(19) United States
(12) Patent Application Publication
(10) Pub. No.: US 2010/0325550 A1
(43) Pub. Date: Dec. 23, 2010

(54) RFID SYSTEMS

(76) Inventors: Chien Yaw Wong, Knebworth (GB); Duncan McFarlane, Cambrige (GB); Da Xing, Cambridge (GB)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/816,759

(22) Filed: Jun. 16, 2010

Related U.S. Application Data
(60) Provisional application No. 61/187,990, filed on Jun. 17, 2009.

(51) Int. Cl. G06F 15/177; G06F 3/048; G06Q 10/00

(52) U.S. Cl. 715/735; 709/220; 715/736; 715/762; 705/28

(57) ABSTRACT

This invention relates to methods, computer program code and apparatus for improved RFID tagging systems. We describe a module for configuring an RFID system comprising a plurality of RFID readers, said RFID system operating in an environment comprising a plurality of RFID tagged entities, the module comprising: code to enable a user to build an interface for defining a state map for said RFID system, said state map comprising a plurality of states representing information about tagged entities within the environment and transitions between said plurality of states; a transition logic module storing transition logic controlling transitions between states wherein said transition logic module is connected to said interface so that transition logic for said state map is defined using said interface; and a database for storing said states, said transitions and said defined transition logic.

### RELATED APPLICATIONS

The present invention claims priority from U.S. Provisional Patent Application No. 61/187,990, filed Jun. 17, 2009.

### FIELD OF THE INVENTION

This invention relates to methods, computer program code and apparatus for improved RFID tagging systems.

### BACKGROUND TO THE INVENTION

RFID tagging systems rely on radio frequency-based communication between a reader and a transponder or tag of various types for identifying objects and have a variety of applications. In an RFID supply chain or a storage system, pallets, cases, items and other associated physical entities can be tagged with RFID tags. These tags are then tracked by RFID readers to provide tracking information about the item (or groups) of product.

Each reader of the RFID system is controlled by a device management system which is custom built for each implementation of the system. The building of such a complex integrated system is time consuming and requires specialist expertise. Background prior art can be found in: “XML based RFID Event Management Framework”, J Xu, W Cheng, W Lei, W Xu, TENCON 2006—IEEE Region 10 Conference (ISBN 1-4244-9549-1), in “ECA Rule-based RFID Data Management”, J. Wu, D. Wang, H. Sheng, 1^{st} Annual RFID Eurasia Conference, 2007 (ISBN 978-975-01-5660-1), and in US2007/0159304.

Management of low-level events and high-level business events in a flexible and reconfigurable manner is a new area, and embodiments of this invention focus on this.

### SUMMARY OF THE INVENTION

According to the invention there is provided a module for configuring an RFID system comprising a plurality of RFID readers, said RFID system operating in an environment comprising a plurality of RFID tagged entities, the module comprising:

means for creating an interface for defining a state map for said RFID system, said state map comprising a plurality of states representing information about tagged entities within the environment and transitions between said plurality of states;

a transition logic module storing transition logic controlling transitions between states wherein said transition logic module is connected to said interface so that transition logic for said state map is defined using said interface; and

a database for storing said states, said transitions and said defined transition logic.

Said interface may be a graphical user interface which allows a user to define said states, said transitions and said transition logic. Said graphical user interface may present a user with a list of options for defining said transition logic. Said graphical user interface may present a user with an option for creating a new transition logic rule. For example, said list of options comprises an option for creating a new transition logic rule.

Said transition logic module may comprise a rules definition module storing predetermined transition logic rules and which may also be configured to allow new transition logic rules to be defined.

According to another aspect of the invention there is provided an RFID system comprising a plurality of RFID readers; a plurality of RFID tagged entities; wherein said RFID system has been configured using said module for configuring said RFID system as defined above.

According to another aspect of the invention there is provided a method of configuring an RFID system comprising a plurality of RFID readers, said RFID system operating in an environment comprising a plurality of RFID tagged entities, the method comprising:

defining the plurality of RFID readers;

defining a plurality of states representing information about tagged entities within the environment;

defining transitions between said plurality of states; and

defining transition logic controlling said defined transitions to create a state map for said RFID system.

The method may comprise defining monitoring conditions for the system, e.g. conditions which trigger alerts for the system.

Transition logic may be defined so as to determine whether a detected tag is a background tag.

According to another aspect of the invention, there is provided a graphical user interface for implementing the above method, said graphical user interface presenting a user with a list of options for each defining step the transition logic and said user selects the appropriate option from the list.

Said list of options may comprise an option for creating a new transition logic rule and said user interface is configured to allow said user to select said option and to input a new rule. The graphical user interface may provide access to all user defined monitoring.

According to another aspect of the invention, there is provided an RFID control system, the system comprising:

a plurality of interfaces for a plurality of RFID readers;

a database for storing states of tags read by said readers and data defining at least one tag state diagram, said tag state diagram defining allowed transitions between states of a said tag;

a user interface to enable a user to define or select rules for said allowed transitions according to a desired operational logic; and

wherein said user interface is further configured to enable said user to define one or more alerts or monitoring conditions; and

wherein said control system is configured to generate a control page responsive to said state diagram and to said one or more alerts or monitoring conditions for display to said user to facilitate control by said user.

There may be a plurality of said tag state diagrams with each said tag associated with one of said tag state diagrams. Said interfaces may comprise interfaces adapted to RFID readers of a plurality of different types of RFID systems; wherein said RFID control system includes a web server and wherein said user interface and said control page comprises graphical user interface web pages to provide a coherent view of said plurality of different types of RFID system.

Further aspects of the invention comprise a system with one or more of the following features:
1. The use of states and transitions for managing high level business events and also for low-level filtering of device events.
2. The use of states and transitions to manage states of business events according, but not limited to, EPC Network Information Systems (EPCIS) standard and Application Level Event (ALE) standard (definitions of names and properties of business events in this standard are hereby incorporated by reference). For example, using the state to define the properties and attributes needed for each events such as OBSERVE, AGGREGATION, DISAGGREGATION, BIZSTEP, BIZLOCATIONS and similar.
3. The use of states and transitions for special RFID operations that has prebuilt business logics tied to specific prebuilt web pages. For example, when system integrators or end users select a particular special state such as the “RFID Tag Writing Operation”, the prebuilt web page will then be automatically generated on the web server for that particular user.
4. The use of states and transitions for managing errors in the system (in particular unexpected events)

The generation of states and transitions will automatically trigger database records associated to the states and transitions events which then trigger the relevant inventory control (and associated web pages) relevant to those states and transitions. This simplifies the system integrators and end-user tasks of managing the whole business events as it removes the need for writing codes for each and every events that require inventory control.

The invention further provides computer program code for controlling a computer or computerized apparatus to implement a method or system as described above. The code may be provided on a carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF THE DRAWINGS

These and other aspects of the invention will now be further described, with reference of the accompanying figures in which:

FIG. 1 shows a schematic block diagram of the components of a toolkit for configuring an RFID system with a plurality of readers reading information from a plurality of tags;

FIG. 2a is a flowchart setting out the steps of the implementation of the management system;

FIG. 2b is a flowchart setting out the details of a step in FIG. 2a;

FIG. 3 is a state map illustrating one configuration of states and allowable transitions; and

FIG. 4 is a state map illustrating a configuration of states and allowable transitions to avoid repeated detection of a background tag.

### DETAILED DESCRIPTION OF THE PREFERRED EMBODIMENTS

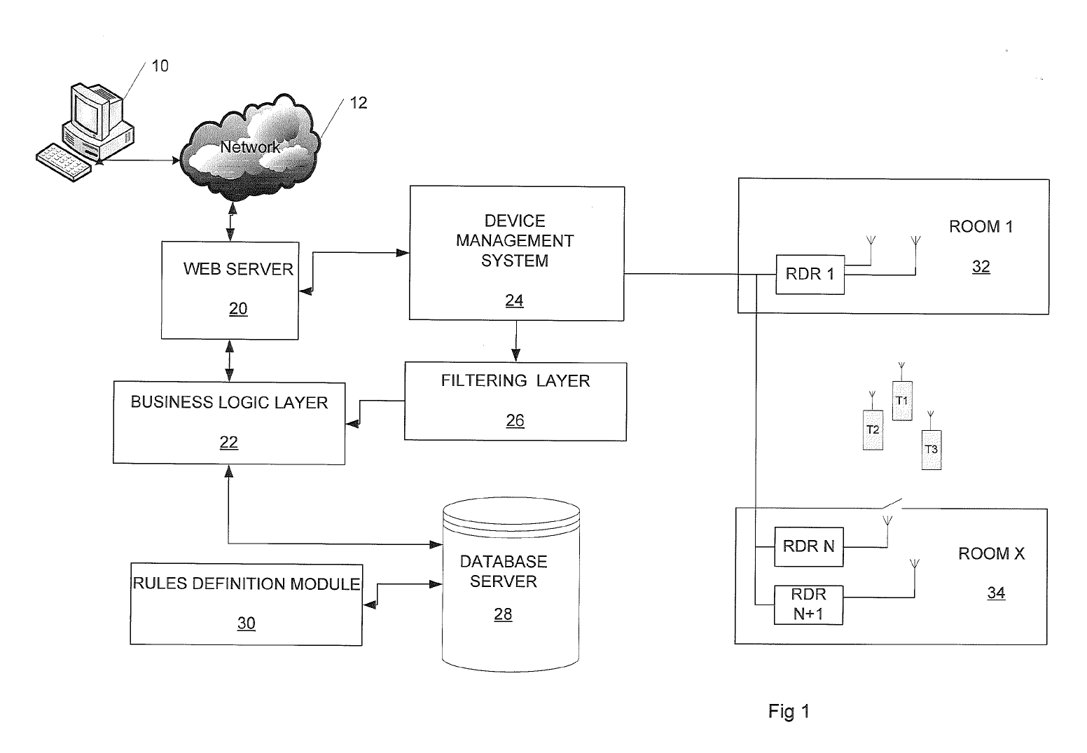

FIG. 1 shows an RFID system comprising a device management system 24 controlling a plurality of readers (RDR1 . . . RDRN, RDRN+1) which detect signals from a plurality of RFID tags (T1, T2, T3, etc.). The readers may be distributed across a plurality of rooms (32, 34) and there may be one or more reader per room. As depicted, reader RDR1 has two antennae and each of reader RDRN, RDRN+1 have one antenna. The antenna of RDRN is directional and monitors movement of the door 36 for entering/exiting room X.

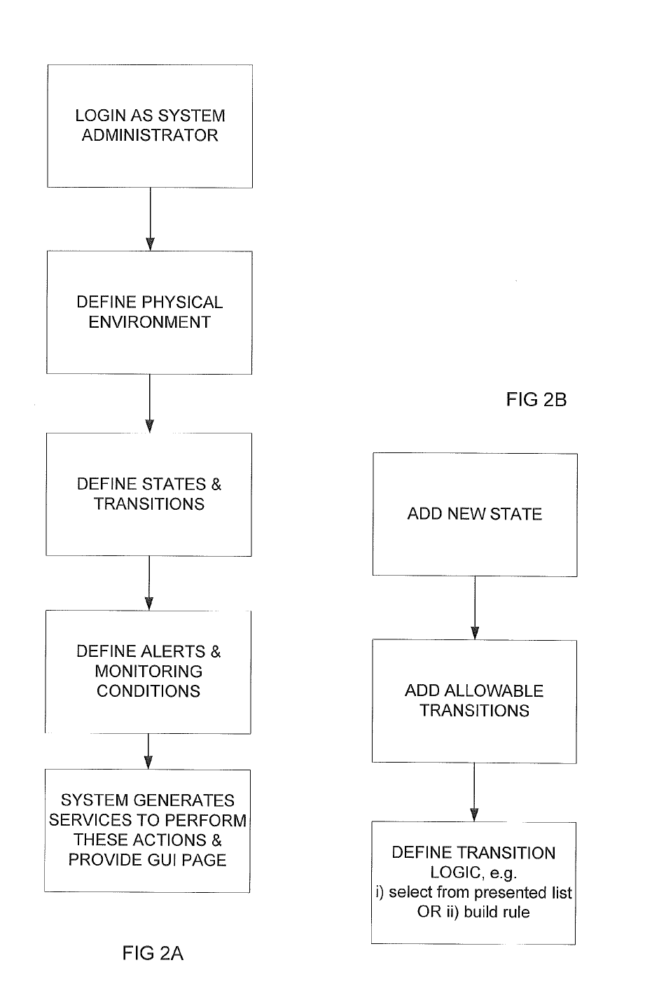

Each reader may A user 10 is connected via a network 12 and a web server 20 to the device management system 24 to set-up the RFID system as set out in FIG. 2. The web server 20 connects the user to a business logic layer module 22 which permits a user to define the logic governing the RFID system. The device management system 24 is connected to the business logic layer module 22 by a filtering layer. The filtering layer 26 filters information received from the readers before passing the information to the business logic layer module 22 for processing.

The business logic layer module 22 is connected to a database server 28 which stores information regarding all elements of the system. The database server 28 thus stores information on the tags (i.e. identification and status (or state) of a tag) and devices (e.g. descriptions, settings and configurations), product identification codes and information on the state map(s) (i.e. states, transitions and transition logic). As explained in more detail below, each state map may be defined using the rules definition module 30 by using predetermined rules stored therein or by using the module to build custom-made rules. Different state maps may be defined for different types of tags, different types of products, etc. However, such state maps may be regarded as sub-diagrams of a state map which describes the entire system.

As shown in FIG. 2a, a user logs in as a system administrator on the user computer 10. The user will be presented with a graphical user interface to guide them through the steps of setting up the RFID system. After login, the next step is to define the physical environment. Thus a user defines the settings for the RFID readers and other readers, e.g. barcode readers, webcams with motion detectors and other general network settings, e.g. time, system name. The settings for the readers may include the manufacturer type and address, number of active and inactive antennae, location, name and any priority for a reader relative to other readers.

Once the environment is defined, the graphical user interface presents the user with the options for defining the state maps/diagrams for the tags in the system. As shown in FIG. 2b, the steps of defining each state map are:

i) add a new state (including providing a name and description)

ii) repeat step (i) as necessary

iii) add allowable transitions from each defined state to other states

iv) repeat step (iii) as necessary

v) define transition logic

The graphical user interface preferably presents the user with a list of possible options for defining the transition logic. For many cases, step (v) may be accomplished by simply selecting the appropriate option. However, to provide greater flexibility, the graphical user interface also allows the user to build a new transition logic rule. The transition logic is converted to XML format.

Once the state map(s) are defined, as shown in FIG. 2a, a user defines the alerts and monitoring conditions for the system. The monitoring may include conducting inventory reviews, e.g. counting movement of and/or states of tags having IDs falling within a specified range. Alerts may be defined so that any errors in the system are clearly flagged to a user. The system then generates services to perform the alerts and monitoring and provides a new graphical user interface for these services. The graphical user interface provides or displays access to all user defined monitoring and is thus dynamic and dependent on the definitions provided by the user. There is an option for machine-to-machine system.

Once all the definitions are completed and the services have been generated, the system is ready to run. Before the system is run, a simulation may be run to detect any errors.

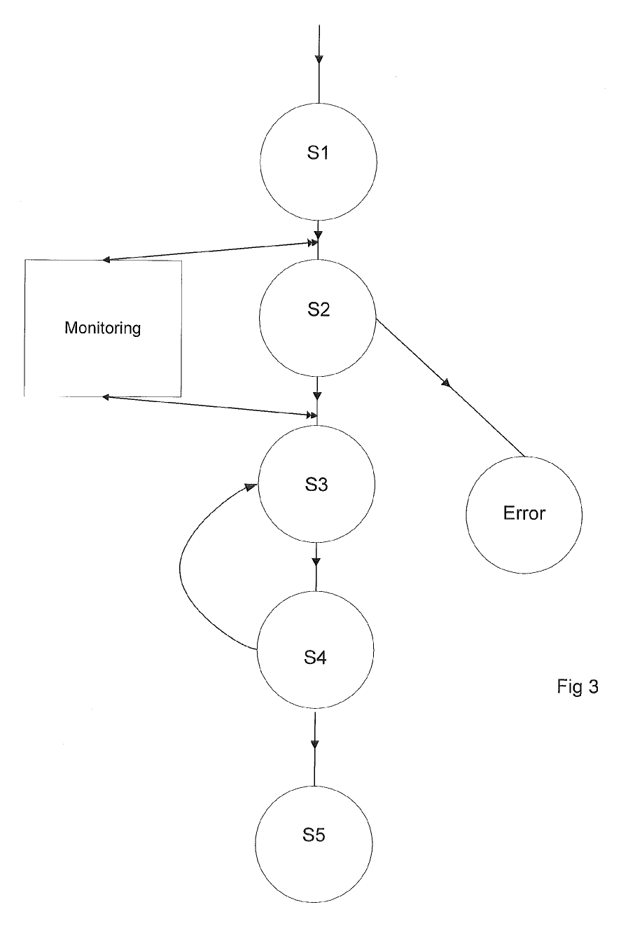

FIG. 3 shows a possible state map generated as set out above. The state map has five states S1 to S5 each having its own description and allowable transitions defined in the table below:

| State | Description | Allowable transitions |
|---|---|---|
| S1 | New tag | To S2 |
| S2 | Checked in tag | To S3 |
| S3 | Tag in storage | To S4 |
| S4 | Tag checked out | To S5 or back to S3 |
| S5 | Tag decommissioned | None |

The transition logic may be selected from a predefined set of rules or may be customisable using a variable {m1}.

An example of predefined logic is:

If in S1 and detected by RDR1 move to S2

The logic may be refined by specifying the antenna of the reader, for example if antennae are directional and monitoring discrete location such as doorways, e.g.

If in S1 and detected by antenna 2 of RDR1 move to S2.

Alternatively, detection by multiple readers may be required to change state, e.g.

If in S1 and detected by antenna 2 of RDR1 and antenna 1 of RDR2 move to S2.

The predefined transition logic may also be refined by specifying a time period for detection.

Alternatively, a user may define the transition logic using the variable {m1} which is a global variable for the system having a true or false state, e.g. has an email from Mr X stating Y arrived. Once this variable is set, the user builds the rule for the transition logic using any or all of the following parameters: reader number, reader antenna, time interval, AND or NOT logic, device identifier (e.g. motion sensor, true/false output, bar code reader), number of times a tag enters/exits state, background tag function.

An RFID tag entering the system, i.e. a tag not previously seen, a reused tag or a reinstated tag that was previously decommissioned, goes to the first state S1 and then progresses through the state map as defined by the transition logic. As shown monitoring may be included, e.g. to monitor movement from S1 to S2 and to monitor movement from S2 to S3. The state map also includes an error state where unusual transition logic occurs.

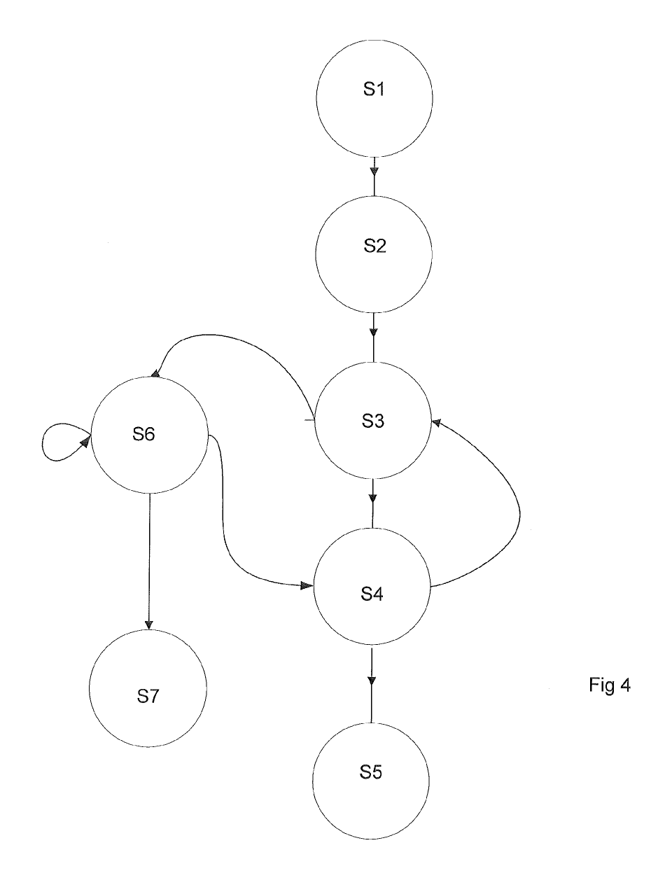

FIG. 4 shows how the state map of FIG. 3 may be adapted to avoid repeated detection of a background tag, i.e. a tag which remains in the same location for a period of time, such a tag on a product in storage. The states in common with FIG. 3 have the same label and description. The state map for FIG. 4 has seven states S1 to S7 (S4 and S5 are not shown for clarity) each having its own description and allowable transitions defined in the table below:

| State | Description | Allowable transitions |
|---|---|---|
| S1 | New tag | To S2 |
| S2 | Checked in tag | To S3 |
| S3 | Tag in storage | To S6 |
| S4 | Tag checked out | Back to S3 (or to S5 not shown) |
| S5 | Tag decommissioned | None |
| S6 | Possible background tag | To S7, loop to S6, or to S4 |
| S7 | Background tag | None |

The transition logic to pass from S2 to S3 and from S4 back to S3 is:

If in S2 and detected by RDR1 move to S3

If in S4 and detected by RDR1 move to S3

Reader RDR1 is also used to detect a change in state from S3 to S6 but this transition logic also includes a time lock on the status S3. Thus the transition logic to pass from S3 to S6 is:

If in S3 and detected by RDR1 for 5 seconds move to S6.

Once in S6, the system applies hidden logic to determine whether or not the detected tag is a background tag. The tag loops from S6 to S6 until one of the conditions defined below is satisfied.

The transition logic to pass from S6 to S7, i.e. when a possible background tag is confirmed to be a background tag, is:

If in S6 and detected by RDR1 more than 50 times in last minute move to S7.

The transition logic to pass from S6 to S3, i.e. when a possible background tag is confirmed not to be a background tag, is:

If in S6 and detected by RDR1 less than 6 times in last minute move to S3.

It will be appreciated that the time interval and number of counts may be varied for each system to ensure that there are no false positive identifications of tags as background tags.

In a typical supply chain, there are movement of goods in the form of pallets and its associated cases containing items of product. There are numerous identification numbers associated to these products, such as, but not limited to:

Pallet identification number (such as case SSCC)

Case identification number (such as case SSCC)

Delivery Notes

Shipment Identification number

Forwarder Identification Number

Sales Order generated by the supplier

Purchase Order from the end-users

These identification numbers are associated to each other with a particular relationship which is typically unique to each supply chain and its organisations. In the embodiments shown in the Figures, the business logic applies primarily to a particular organisation in the supply chain. However, by appropriate definitions of states and transitions the system may be easily adapted to define the transfer between organisations in a supply chain. For example, each supply chain organisation may have an associated state and the transition, e.g. receiving or shipping, may be defined between the two states.

The system may be set-up so as to capture, record and report the appropriate RFID information in the correct data format as required by each supply chain organisation. In particular, reporting may be in the form of an “Advanced Shipping Notice” or ASN containing information such as, but not limited to, pallets and cases identification numbers, delivery notes, departure dates, arrival dates etc will be sent from the “shipper” to the “receiver”—to notify the receiver in advance of the incoming deliveries of goods. The association of the product and related RFID information can be sent beforehand via ASN to the “receiver” to facilitate and automate the receiving process. This ASN message can be sent in a variety of ways, but the most common method is through an Electronic Data Interchange (or EDI).

No doubt many other effective alternatives will occur to the skilled person. It will be understood that the invention is not limited to the described embodiments and encompasses modifications apparent to those skilled in the art lying within the spirit and scope of the claims appended hereto.

We claim:

1. A computer system to enable a user to configure an RFID system, said RFID system comprising a plurality of RFID readers and operating in an environment comprising a plurality of RFID tagged entities, the computer system comprising:
a module to enable said user to create a graphical user interface, wherein said created graphical user interface is usable to define a state map for said RFID system, said state map comprising a plurality of states representing information about tagged entities within the environment and transitions between said plurality of states;
a transition logic module storing transition logic controlling transitions between states wherein said transition logic module is connected to said interface so that transition logic for said state map is defined using said interface; and
a database for storing said states, said transitions and said defined transition logic; and
wherein
said created graphical user interface is further operable to:
define said plurality of RFID readers;
define a plurality of states representing information about tagged entities within the environment;
define transitions between said plurality of states; and
define transition logic controlling said defined transitions to create said state map for said RFID system.

2. A computer system according to claim 1, wherein said created graphical user interface is further operable to define: monitoring conditions which trigger alerts for the system, and transition logic so to determine whether a detected tag is a background tag.

3. A computer system according to claim 2, wherein said module to enable said user to creating said graphical user interface is configured to present said user with a list of options for each defining step the transition logic to enable said user to select the appropriate option from the list to build said graphical user interface, wherein said list of options comprises an option for creating a new transition logic rule and said user interface is configured to allow said user to select said option and to input a new said rule.

4. A computer system according to claim 3, in combination with said RFID system, wherein said RFID system further comprises a plurality of interfaces for said plurality of RFID readers, wherein said interfaces comprise interfaces adapted to RFID readers of a plurality of different types of RFID systems, and wherein said database stores said states of tags read by said readers and data defining at least one tag state diagram, said tag state diagram defining allowed transitions between states of a said tag; and wherein said computer system includes a web server and is further configured to generate a control page responsive to said at least one stored state diagram and to said monitoring conditions for display to said user to facilitate control by said user, wherein said control page comprises one or more graphical user interface web pages to provide a coherent view of said plurality of different types of RFID system

5. A computer system according to claim 4, further programmed to enable a user to manage business events tracked by the RFID system, the computer system including an RFID tag tracking system, said tag tracking system including a configurable state machine to enable a user to define a configurable function of said RFID tag tracking system, wherein said state machine comprises a plurality of said user-defined states and user-defined conditional transitions between said states, and wherein at least some of said states represent business events within said RFID system, wherein a said business event comprises an event having associated data linking one or more RFID tags to identifiers to one or more physical product or entity identifiers.

6. A computer system according to claim 5 further comprising a user interface module to automatically generate a management user interface for managing said RFID system from said user-defined states and transitions.

7. A computer system according to claim 6, wherein said states include one or more states to represent errors in otherwise impermissible states of said RFID system.

8. A computer system including a module for configuring an RFID system comprising a plurality of RFID readers, said RFID system operating in an environment comprising a plurality of RFID tagged entities, the module comprising:
code to enable a user to build an interface for defining a state map for said RFID system, said state map comprising a plurality of states representing information about tagged entities within the environment and transitions between said plurality of states;
a transition logic module storing transition logic controlling transitions between states wherein said transition logic module is connected to said interface so that transition logic for said state map is defined using said interface; and
a database for storing said states, said transitions and said defined transition logic.

9. A computer system according to claim 8, wherein said interface is a graphical user interface which allows a user to define said states, said transitions and said transition logic, wherein said graphical user interface presents a user with a list of options for defining said transition logic, wherein said list of options comprises an option for creating a new transition logic rule, wherein said transition logic module comprises a rules definition module storing predetermined transition logic rules, and wherein said rules definition module is configured to allow new transition logic rules to be defined.

10. A computer system including a module as claimed in claim 8, for interfacing with an RFID system, the computer system being programmed to enable a user to manage business events tracked by the RFID system, the computer system comprising: an RFID tag tracking system, said tag tracking system including a configurable state machine to enable a user to define a configurable function of said RFID tag tracking system, wherein said state machine comprises a plurality of user-defined states and user-defined conditional transitions between said states, and wherein at least some of said states represent business events within said RFID system, wherein a said business event comprises an event having associated data linking one or more RFID tags to identifiers to one or more physical product or entity identifiers.

11. A computer system for interfacing with an RFID system as claimed in claim 10 further comprising a user interface module to automatically generate a management user interface for managing said RFID system from said user-defined states and transitions.

12. A computer system for interfacing with an RFID system as claimed in claim 10 further comprising at least one pre-built set of states and state transitions, selectable by a user for use in said state machine, wherein a said pre-built set of states and state transitions has an associated user interface page for managing a portion of said RFID system.

13. A computer system for interfacing with an RFID system as claimed in claim 10 further comprising a system configuration user interface to enable a user to define said states and transitions of said state machine.

14. A computer system for interfacing with an RFID system as claimed in claim 10, wherein said states include one or more states to represent errors in otherwise impermissible states of said RFID system.

15. A computer system for interfacing with an RFID system as claimed in claim 10 further comprising a database and wherein one or both of said states and transitions automatically trigger updating of said database with inventory control business event data, wherein a said state comprises information representing one or more of a tag identifier, location and tag detection event time and in addition data relating to a cause of a tag detection event.

16. An RFID control system, the system comprising:
a plurality of interfaces for a plurality of RFID readers;
a database for storing states of tags read by said readers and data defining at least one tag state diagram, said tag state diagram defining allowed transitions between states of a said tag;
a user interface to enable a user to define or select rules for said allowed transitions according to a desired operational logic; and
wherein said user interface is further configured to enable said user to define one or more alerts or monitoring conditions; and
wherein said control system is configured to generate a control page responsive to said state diagram and to said one or more alerts or monitoring conditions for display to said user to facilitate control by said user.

17. An RFID control system according to claim 16 having a plurality of said tag state diagrams and wherein each said tag is associated with one of said tag state diagrams, and wherein said interfaces comprise interfaces adapted to RFID readers of a plurality of different types of RFID systems; wherein said RFID control system includes a web server and wherein said user interface and said control page comprises graphical user interface web pages to provide a coherent view of said plurality of different types of RFID system.

18. A method of using an RFID control system as claimed in claim 16 to configure an RFID system comprising a plurality of RFID readers, the RFID system operating in an environment comprising a plurality of RFID tagged entities, the method comprising:
defining the plurality of RFID readers;
defining a plurality of states representing information about tagged entities within the environment;
defining transitions between said plurality of states; and
defining transition logic controlling said defined transitions to create a state map for said RFID system.

19. A method according to claim 18, further comprising defining monitoring conditions which trigger alerts for the system, and defining said transition logic so as to determine whether a detected tag is a background tag; and wherein said method is implemented using a graphical user interface, said graphical user interface presenting a user with a list of options for each defining step the transition logic and said user selects the appropriate option from the list.

20. A method according to claim 19, wherein said list of options comprises an option for creating a new transition logic rule, the method comprising inputting from a user a selection of said option for creating a new transition logic rule, inputting a new said transition logic rule, and providing access to said user defined monitoring which triggers alerts for the system.
